(19) United States
(12) Patent Application Publication
(10) Pub. No.: US 2026/0043982 A1
(43) Pub. Date: Feb. 12, 2026

(54) HIGH-DENSITY OPTICAL CABLE SEALING ASSEMBLY AND OPTICAL FIBER CONNECTOR BOX

(71) Applicant: ACCELIGHT TECHNOLOGIES (WUHAN) INC., Wuhan (CN)

(72) Inventors: GONG-EN GU, Wuhan (CN); Matthew John Steven Rouleau, Wuhan (CN); Neil Santos, Wuhan (CN); William Sterling, Wuhan (CN); Iuliu Cosmin Gordea, Wuhan (CN); Hengzhi FAN, Wuhan (CN); Wenbing ZHU, Wuhan (CN); Zhehuanyan MEI, Wuhan (CN); Fei LI, Wuhan (CN)

(73) Assignee: ACCELIGHT TECHNOLOGIES (WUHAN) INC., Wuhan (CN)

(21) Appl. No.: 19/364,110

(22) Filed: Oct. 21, 2025

(51) Int. Cl. G02B 6/44

(52) U.S. Cl. CPC G02B 6/44775; G02B 6/44465

(57) ABSTRACT

A high-density optical cable sealing assembly includes a first injection-molded part, a gel part capable of elastically deforming, and a second injection-molded part. The first injection-molded part is provided with a first profiling groove for inserting the gel part, and the second injection-molded part is provided with a second profiling groove for inserting the gel part. The first injection-molded part is provided with a plurality of first optical fiber mounting holes for mounting optical fibers and a first connecting hole used for being fixedly connected with the second injection-molded part through a threaded fastener. This disclosure is simple in structure and convenient to assemble, and the number of available fiber outlet holes can be effectively increased. Meanwhile, the optical fiber connector box can have good waterproof performance when a flat leather fiber optical cable is arranged in the optical fiber connector box.

### TECHNICAL FIELD

This disclosure relates to the technical field of optical fibers, and in particular, to a high-density optical cable sealing assembly and an optical fiber connector box.

### BACKGROUND

The main function of an optical fiber connector box is to split the optical cable, that is, a device that splits an optical cable into an individual optical fiber, which is mounted on a wall, a cable, a utility pole, or in a sewer as a user optical cable connector box. The function of the optical fiber connector box is to provide fusion splicing between optical fibers, fusion splicing between optical fibers and pigtails, as well as cross-connection of optical connectors. The optical fiber connector box is mainly applicable to straight-through and branch connection that are laid in a manner such as aerial, duct, and direct burial of optical cables of various structures. After the optical cable enters the optical fiber connector box, the outer sheath and the reinforcing core thereof shall be mechanically fixed, a ground wire protection component shall be added, end-head protection treatment shall be carried out, and the optical fibers shall be grouped and protected.

In the prior art, the following technical solution is usually used to fix the parts located in the optical fiber connector box: as shown in FIG. 11 to FIG. 15, the optical fiber connector box sealing assembly includes two conventional circular holes, and the optical fiber connector box sealing assembly is specially designed for tapping the optical cable, and therefore, its assembly must be divided into two components: an upper housing and a lower housing, which are separated from each other in an up-down direction (as shown in FIG. 15), and the two components are mounted in a splicing manner; and as a result, the optical fiber connector box sealing assembly in the prior art has the following defects:
even if the same type of branching clamp is used, the optical fiber connector box sealing assembly with two conventional circular holes can only split up to six fiber outlet holes; however, with the development of the optical communication industry, customers have increasingly higher demands for use, and there are more and more requirements for fiber outlet holes of the optical fiber connector box; the original 6-hole design has been far from meeting the increasing requirements; and in addition, the upper and lower splicing mounting of the two components fails to ensure waterproof performance.

Therefore, there is an urgent need to design a high-density optical cable sealing assembly to solve the above technical problems.

### SUMMARY

The technical problem to be solved in this disclosure is to provide a high-density optical cable sealing assembly and an optical fiber connector box, aiming at defects in the prior art, which is simple in structure and convenient to assemble, and the number of available fiber outlet holes can be effectively increased; meanwhile, the optical fiber connector box can have good waterproof performance when a flat leather fiber optical cable is arranged in the optical fiber connector box; and the bearing capacity of the optical fiber connector box is also improved, allowing the optical fiber connector box to be applied to more usage scenarios.

A technical solution adopted by this disclosure to solve the technical problem is as follows: this disclosure provides a high-density optical cable sealing assembly, including a first injection-molded part, a gel part capable of elastically deforming, and a second injection-molded part, where the first injection-molded part is provided with a first profiling groove for inserting the gel part, the second injection-molded part is provided with a second profiling groove for inserting the gel part, the first injection-molded part is provided with a plurality of first optical fiber mounting holes for mounting optical fibers and a first connecting hole used for being fixedly connected with the second injection-molded part through a threaded fastener, the gel part is provided with a plurality of second optical fiber mounting holes for mounting optical fibers and a second connecting hole for the threaded fastener to pass through, the second injection-molded part is provided with a plurality of third optical fiber mounting holes for mounting optical fibers and a third connecting hole used for being fixedly connected with the second injection-molded part through the threaded fastener, the first optical fiber mounting holes, the second optical fiber mounting holes, and the third optical fiber mounting holes are coaxially arranged in a one-to-one correspondence, the first connecting hole, the second connecting hole, and the third connecting hole are coaxially arranged in a one-to-one correspondence, and a branching clamp is disposed in each of the coaxially arranged first optical fiber mounting hole, second optical fiber mounting hole, and third optical fiber mounting hole.

In a preferred embodiment of this disclosure, a diameter of the first optical fiber mounting hole corresponds to a diameter of the third optical fiber mounting hole.

In a preferred embodiment of this disclosure, a diameter of the second optical fiber mounting hole is less than or equal to the diameter of the first optical fiber mounting hole.

In a preferred embodiment of this disclosure, the branching clamp is a flat leather fiber branching clamp or a bundle-like fiber branching clamp.

In a preferred embodiment of this disclosure, a cross-sectional shape of the flat leather fiber branching clamp is I-shaped, and an outer diameter of the flat leather fiber branching clamp corresponds to the diameter of the first optical fiber mounting hole.

In a preferred embodiment of this disclosure, an outer peripheral surface of the flat leather fiber branching clamp and inner peripheral surfaces of the first optical fiber mounting hole, the second optical fiber mounting hole, and the third optical fiber mounting hole enclose two flat leather fiber optical cable mounting holes arranged in mirror symmetry, and a cross-sectional shape of the flat leather fiber optical cable mounting hole corresponds to a cross-sectional shape of a flat leather fiber optical cable.

In a preferred embodiment of this disclosure, the bundle-like fiber branching clamp includes three fan-shaped body portions arranged in rotational symmetry relative to a central axis of the first optical fiber mounting hole, the center of each fan-shaped body portion is located on the central axis of the first optical fiber mounting hole, and an outer diameter of each fan-shaped body portion corresponds to the diameter of the first optical fiber mounting hole.

In a preferred embodiment of this disclosure, an outer peripheral surface of the bundle-like fiber branching clamp and inner peripheral surfaces of the first optical fiber mounting hole, the second optical fiber mounting hole, and the third optical fiber mounting hole enclose three bundle-like fiber optical cable mounting holes arranged in rotational symmetry, and a cross-sectional shape of the bundle-like fiber mounting hole corresponds to a cross-sectional shape of a bundle-like fiber optical cable.

In a preferred embodiment of this disclosure, a central axis of the first injection-molded part is coaxially arranged with a central axis of the first connecting hole.

This disclosure further discloses an optical fiber connector box, which comprises a high-density optical cable sealing assembly.

Beneficial effects of this disclosure are as follows:
1. This disclosure is simple in structure and convenient to assemble, and the number of available fiber outlet holes can be effectively increased; meanwhile, the optical fiber connector box can have good waterproof performance when a flat leather fiber optical cable is arranged in the optical fiber connector box; and the bearing capacity of the optical fiber connector box is also improved, allowing the optical fiber connector box to be applied to more usage scenarios.
2. Advantage of this disclosure in being adaptable to a high-density pipeline: according to this disclosure, high-density optical fiber mounting is realized through the plurality of coaxially and correspondingly arranged optical fiber mounting holes, and at most 24 fiber outlet holes can be split up, thereby meeting the continuously growing high-density requirements of customers.
3. Flexible mounting of this disclosure: this disclosure can accommodate different types of branching clamps by designing optical fiber mounting holes with different diameters, including the flat leather fiber branching clamp and the bundle-like fiber branching clamp, thereby providing a more flexible mounting option.
4. Integrally formed design of this disclosure: this disclosure adopts an integrally formed structure, which avoids the upper and lower separated components of the original sealing assembly, simplifies the mounting process, and improves the convenience of mounting.
5. Strong compatibility of this disclosure: the design of each optical fiber mounting hole of this disclosure takes into account the cross-sectional shapes of different types of optical cables, ensuring compatibility with the flat leather fiber optical cable and the bundle-like fiber optical cable.
6. Good sealing performance of this disclosure: the elastic deformation characteristic of the gel part of this disclosure enables the optical cable to be clamped by extrusion to form a closed space, which effectively prevents air leakage and improves the sealing performance.
7. This disclosure introduces an innovative design in the field of optical fiber connector boxes, effectively improving the performance of optical fiber connector box and adapting to the requirements of the continuously developing optical communication industry.

### BRIEF DESCRIPTION OF THE DRAWINGS

This disclosure is further described below with reference to the accompanying drawings and embodiments, in the accompanying drawings:

FIG. 1 is a schematic diagram of a high-density optical cable sealing assembly according to an embodiment of this disclosure;

FIG. 2 is an exploded view of a high-density optical cable sealing assembly according to an embodiment of this disclosure;

FIG. 3 is a schematic diagram of a flat leather fiber branching clamp of a high-density optical cable sealing assembly according to an embodiment of this disclosure;

FIG. 4 is an exploded assembly view of a flat leather fiber branching clamp of a high-density optical cable sealing assembly according to an embodiment of this disclosure;

FIG. 5 is an assembly view of a flat leather fiber branching clamp of a high-density optical cable sealing assembly according to an embodiment of this disclosure;

FIG. 6 is a mounting view of a flat leather fiber optical cable of a high-density optical cable sealing assembly according to an embodiment of this disclosure;

FIG. 7 is a top view of a bundle-like fiber branching clamp of a high-density optical cable sealing assembly according to an embodiment of this disclosure;

FIG. 8 is an exploded assembly view of a bundle-like fiber branching clamp of a high-density optical cable sealing assembly according to an embodiment of this disclosure;

FIG. 9 is an assembly view of a bundle-like fiber branching clamp of a high-density optical cable sealing assembly according to an embodiment of this disclosure;

FIG. 10 is a mounting view of a bundle optical fiber of a high-density optical cable sealing assembly according to an embodiment of this disclosure;

FIG. 11 is an assembly view of a bundle-like fiber branching clamp in the prior art;

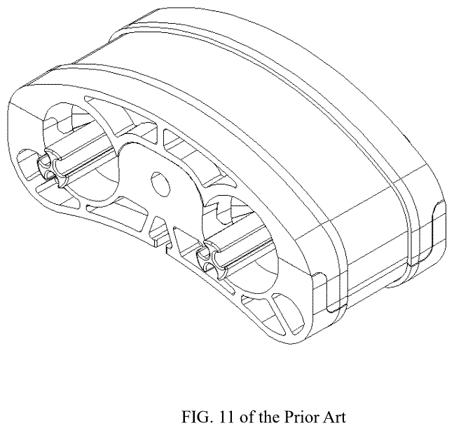

FIG. 12 is a front view of a bundle-like fiber branching clamp in the prior art;

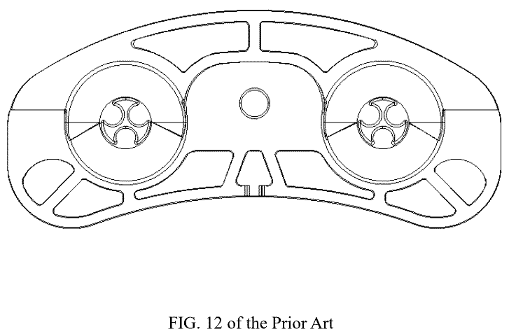

FIG. 13 is an assembly view of a flat leather fiber optical cable in the prior art;

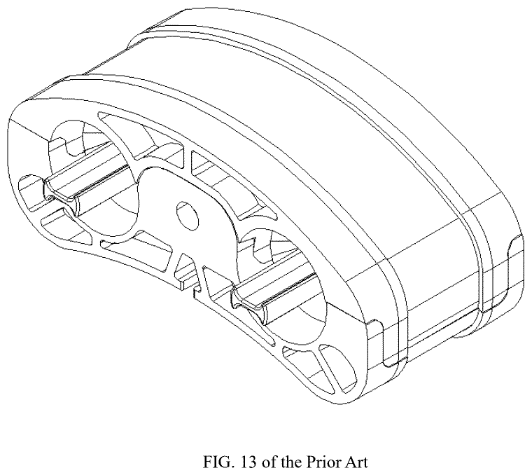

FIG. 14 is a front view of a flat leather fiber optical cable in the prior art; and

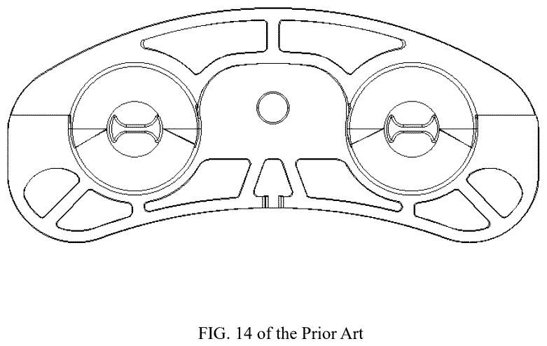

FIG. 15 is an exploded view of an optical cable sealing assembly in the prior art.

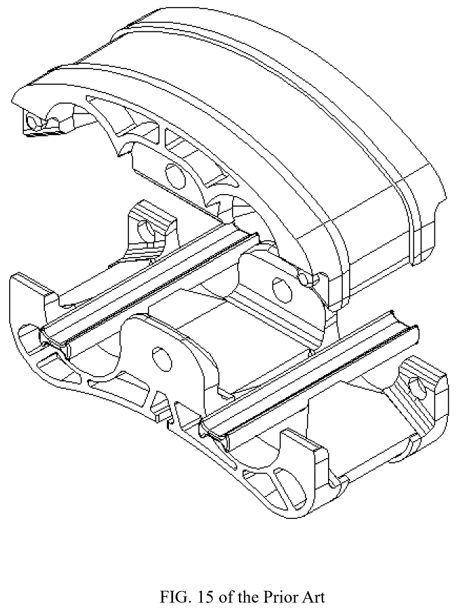

### DETAILED DESCRIPTION OF THE EMBODIMENTS

To make the purposes, technical solutions, and advantages of this disclosure clearer, the following further describes this disclosure in detail with reference to the accompanying drawings and embodiments. It should be understood that the specific embodiments described herein are merely intended to explain this disclosure, but not to limit this disclosure.

### Embodiment 1

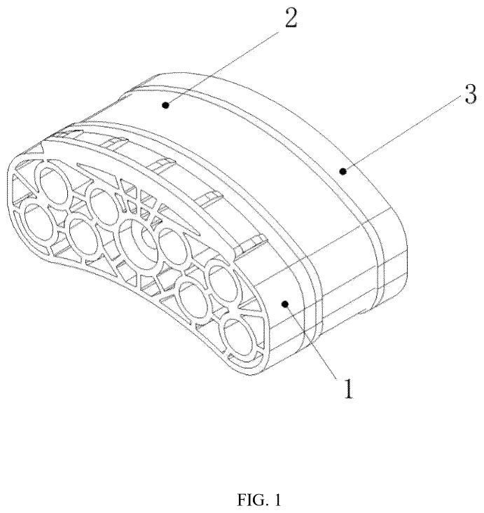

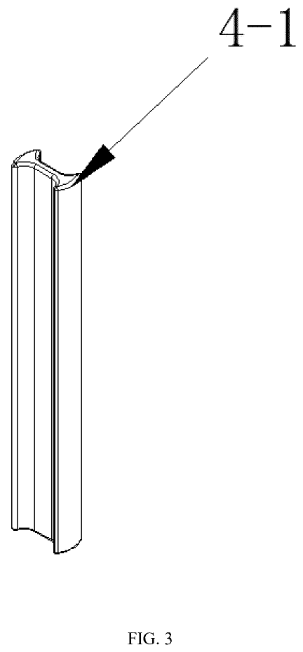

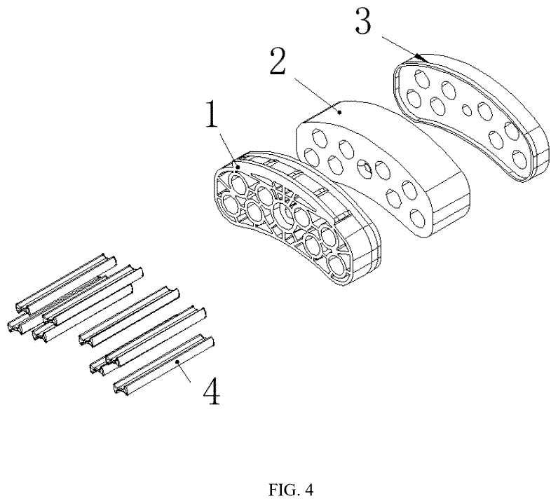

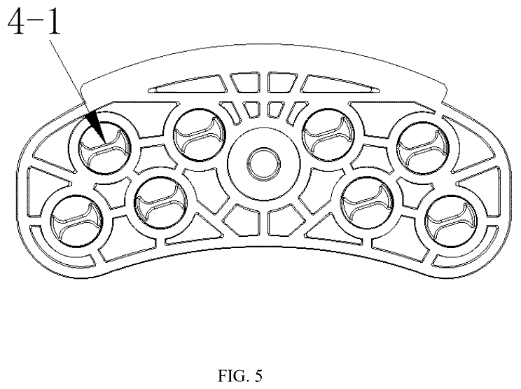

As shown in FIG. 1 to FIG. 6, a high-density optical cable sealing assembly includes a first injection-molded part 1, a gel part 2 capable of elastically deforming, and a second injection-molded part 3, where the first injection-molded part 1 is provided with a first profiling groove 1-1 for inserting the gel part 2, the second injection-molded part 3 is provided with a second profiling groove 3-1 for inserting the gel part 2, the first injection-molded part 1 is provided with a plurality of first optical fiber mounting holes 1-2 for mounting optical fibers and a first connecting hole 1-3 used for being fixedly connected with the second injection-molded part 3 through a threaded fastener, the gel part 2 is provided with a plurality of second optical fiber mounting holes 2-1 for mounting optical fibers and a second connecting hole 2-2 for the threaded fastener to pass through, the second injection-molded part 3 is provided with a plurality of third optical fiber mounting holes 3-2 for mounting optical fibers and a third connecting hole 3-3 used for being fixedly connected with the second injection-molded part 3 through the threaded fastener, the first optical fiber mounting holes 1-2, the second optical fiber mounting holes 2-1, and the third optical fiber mounting holes 3-2 are coaxially arranged in a one-to-one correspondence, the first connecting hole 1-3, the second connecting hole 2-2, and the third connecting hole 3-3 are coaxially arranged in a one-to-one correspondence, and a branching clamp 4 is disposed in each of the coaxially arranged first optical fiber mounting hole 1-2, second optical fiber mounting hole 2-1, and third optical fiber mounting hole 3-2. A diameter of the first optical fiber mounting hole 1-2 corresponds to a diameter of the third optical fiber mounting hole 3-2. A diameter of the second optical fiber mounting hole 2-1 is less than or equal to the diameter of the first optical fiber mounting hole 1-2. The branching clamp 4 is a flat leather fiber branching clamp 4-1. A cross-sectional shape of the flat leather fiber branching clamp 4-1 is I-shaped, and an outer diameter of the flat leather fiber branching clamp 4-1 corresponds to the diameter of the first optical fiber mounting hole 1-2. An outer peripheral surface of the flat leather fiber branching clamp 4-1 and inner peripheral surfaces of the first optical fiber mounting hole 1-2, the second optical fiber mounting hole 2-1, and the third optical fiber mounting hole 3-2 enclose two bundle-like fiber mounting holes arranged in mirror symmetry, and a cross-sectional shape of the bundle-like fiber mounting hole corresponds to a cross-sectional shape of a bundle-like fiber optical cable 6 which may be a flat leather fiber optical cable. The flat leather fiber optical cable is mounted in the bundle-like fiber mounting hole.

### Embodiment 2

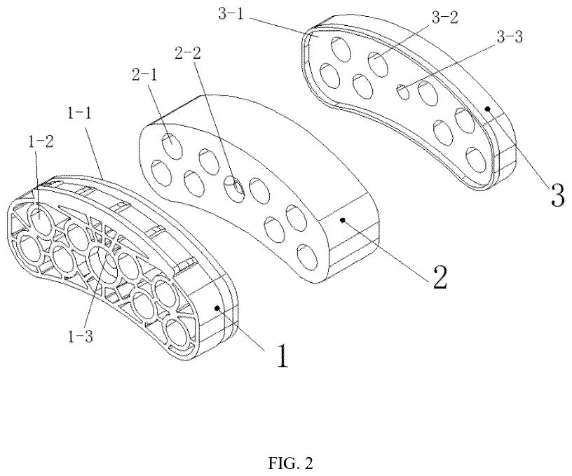

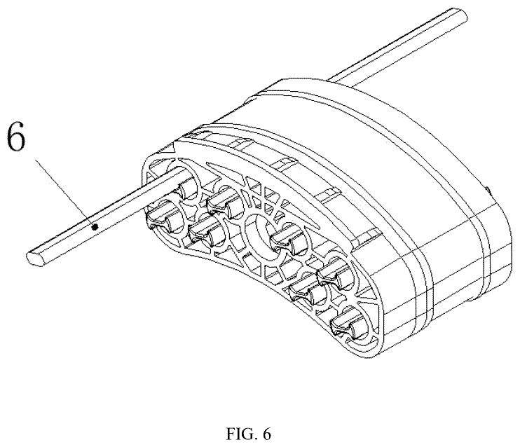

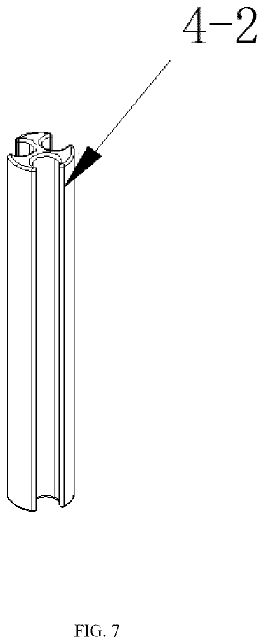

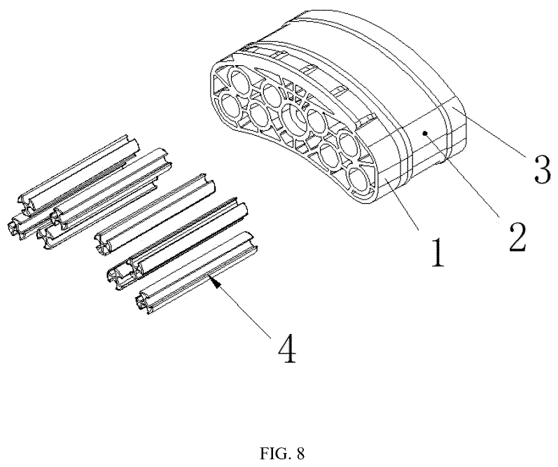

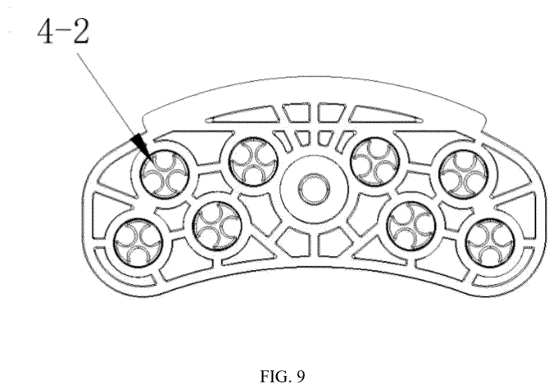

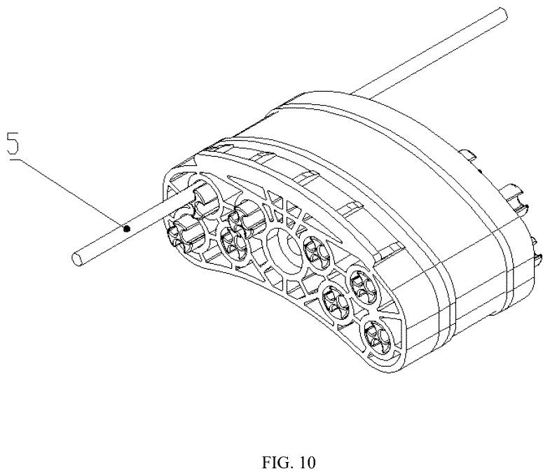

As shown in FIG. 1, FIG. 2, and FIG. 7 to FIG. 10, a high-density optical cable sealing assembly includes a first injection-molded part 1, a gel part 2 capable of elastically deforming, and a second injection-molded part 3, where the first injection-molded part 1 is provided with a first profiling groove 1-1 for inserting the gel part 2, the second injection-molded part 3 is provided with a second profiling groove 3-1 for inserting the gel part 2, the first injection-molded part 1 is provided with a plurality of first optical fiber mounting holes 1-2 for mounting optical fibers and a first connecting hole 1-3 used for being fixedly connected with the second injection-molded part 3 through a threaded fastener, the gel part 2 is provided with a plurality of second optical fiber mounting holes 2-1 for mounting optical fibers and a second connecting hole 2-2 for the threaded fastener to pass through, the second injection-molded part 3 is provided with a plurality of third optical fiber mounting holes 3-2 for mounting optical fibers and a third connecting hole 3-3 used for being fixedly connected with the second injection-molded part 3 through the threaded fastener, the first optical fiber mounting holes 1-2, the second optical fiber mounting holes 2-1, and the third optical fiber mounting holes 3-2 are coaxially arranged in a one-to-one correspondence, the first connecting hole 1-3, the second connecting hole 2-2, and the third connecting hole 3-3 are coaxially arranged in a one-to-one correspondence, and a branching clamp 4 is disposed in each of the coaxially arranged first optical fiber mounting hole 1-2, second optical fiber mounting hole 2-1, and third optical fiber mounting hole 3-2. A diameter of the first optical fiber mounting hole 1-2 corresponds to a diameter of the third optical fiber mounting hole 3-2. A diameter of the second optical fiber mounting hole 2-1 is less than or equal to the diameter of the first optical fiber mounting hole 1-2. The branching clamp 4 is a bundle-like fiber branching clamp 4-2. The bundle-like fiber branching clamp 4-2 includes three fan-shaped body portions arranged in rotational symmetry relative to a central axis of the first optical fiber mounting hole 1-2, the center of each fan-shaped body portion is located on the central axis of the first optical fiber mounting hole 1-2, and an outer diameter of each fan-shaped body portion corresponds to the diameter of the first optical fiber mounting hole 1-2. An outer peripheral surface of the bundle-like fiber branching clamp 4-2 and inner peripheral surfaces of the first optical fiber mounting hole 1-2, the second optical fiber mounting hole 2-1, and the third optical fiber mounting hole 3-2 enclose three bundle-like fiber optical cable mounting holes arranged in rotational symmetry, and a cross-sectional shape of the bundle-like fiber mounting hole corresponds to a cross-sectional shape of a bundle optical fiber 5 or the bundle-like fiber optical cable 6. As shown in FIG. 6 and FIG. 10, the bundle optical fiber 5 or the bundle-like fiber optical cable 6 is mounted in the bundle-like fiber optical cable mounting hole.

### Embodiment 3

A high-density optical cable sealing assembly includes a first injection-molded part 1, a gel part 2 capable of elastically deforming, and a second injection-molded part 3. The first injection-molded part 1 is provided with a first profiling groove 1-1 for inserting the gel part 2, and the second injection-molded part 3 is provided with a second profiling groove 3-1 for inserting the gel part 2. The first injection-molded part 1 is provided with a plurality of first optical fiber mounting holes 1-2 for mounting optical fibers and a first connecting hole 1-3 used for being fixedly connected with the second injection-molded part 3 through a threaded fastener. The gel part 2 is provided with a plurality of second optical fiber mounting holes 2-1 for mounting optical fibers and a second connecting hole 2-2 for the threaded fastener to pass through. The second injection-molded part 3 is provided with a plurality of third optical fiber mounting holes 3-2 for mounting optical fibers and a third connecting hole 3-3 used for being fixedly connected with the second injection-molded part 3 through the threaded fastener. The first optical fiber mounting holes 1-2, the second optical fiber mounting holes 2-1, and the third optical fiber mounting holes 3-2 are coaxially arranged in a one-to-one correspondence, and the first connecting hole 1-3, the second connecting hole 2-2, and the third connecting hole 3-3 are coaxially arranged in a one-to-one correspondence. A branching clamp 4 is disposed in each of the coaxially arranged first optical fiber mounting hole 1-2, second optical fiber mounting hole 2-1, and third optical fiber mounting hole 3-2. A diameter of the first optical fiber mounting hole 1-2 corresponds to a diameter of the third optical fiber mounting hole 3-2. A diameter of the second optical fiber mounting hole 2-1 is less than or equal to the diameter of the first optical fiber mounting hole 1-2. The branching clamp 4 is a specially designed branching clamp, and is applicable to a special optical cable type.

### Embodiment 4

A high-density optical cable sealing assembly is composed of a first injection-molded part 1, a gel part 2 capable of elastically deforming, and a second injection-molded part 3. The first injection-molded part 1 is provided with a first profiling groove 1-1, and the second injection-molded part 3 is provided with a second profiling groove 3-1 for inserting the gel part 2. The first injection-molded part 1 is further provided with a plurality of first optical fiber mounting holes 1-2 for mounting optical fibers and a first connecting hole 1-3 used for being fixedly connected with the second injection-molded part 3 through a threaded fastener. The gel part 2 is provided with a plurality of second optical fiber mounting holes 2-1 for mounting optical fibers and a second connecting hole 2-2 for the threaded fastener to pass through. The second injection-molded part 3 is provided with a plurality of third optical fiber mounting holes 3-2 for mounting optical fibers and a third connecting hole 3-3 used for being fixedly connected with the second injection-molded part 3 through the threaded fastener. The first optical fiber mounting holes 1-2, the second optical fiber mounting holes 2-1, and the third optical fiber mounting holes 3-2 are coaxially arranged in a one-to-one correspondence, and the first connecting hole 1-3, the second connecting hole 2-2, and the third connecting hole 3-3 are coaxially arranged in a one-to-one correspondence. A branching clamp 4 is disposed in each of the coaxially arranged first optical fiber mounting hole 1-2, second optical fiber mounting hole 2-1, and third optical fiber mounting hole 3-2. A diameter of the first optical fiber mounting hole 1-2 corresponds to a diameter of the third optical fiber mounting hole 3-2. A diameter of the second optical fiber mounting hole 2-1 is less than or equal to the diameter of the first optical fiber mounting hole 1-2. The branching clamp 4 is a high-density branching clamp having a special material and structure, and is applicable to different environments and optical cable types.

This disclosure further discloses an optical fiber connector box, which comprises a high-density optical cable sealing assembly.

Further, the first injection-molded part 1, a gel part 2 capable of elastically deforming, and a second injection-molded part 3 of this disclosure are integrally formed as a complete whole by means of compression molding; and the gel part 2 has good elasticity, and when sealing, the parts 1-2 are deformed by extruding the first injection-molded part 1 and the second injection-molded part 3 to extrude the optical cable inwards, thereby clamping the optical cable to form a closed space and preventing air leakage from the fiber outlet hole. The spacing between the first injection-molded part 1 and the second injection-molded part 3 can be adjusted and locked by threaded parts passing through the first connecting hole 1-3, the second connecting hole 2-2, and the third connecting hole 3-3.

From these embodiments, it can be seen that this disclosure has flexibility, adaptability and high customizability, and can meet the requirements of different users, environments and application scenarios.

It should be noted that the flat leather fiber branching clamp 4-1, the bundle-like fiber branching clamp 4-2, the bundle optical fiber 5, and the bundle-like fiber optical cable 6 of this disclosure all belong to the prior art.

In the description of this disclosure, it should be noted that, the orientations or positional relationships indicated by the terms “up”, “down”, etc. are based on those shown in the accompanying drawings, intended only for the convenience of describing this disclosure and for simplifying the description, and not intended to indicate or imply that the referred apparatus or element must be provided with a particular orientation or constructed and operated with a particular orientation, therefore not allowed to be construed as a limitation of this disclosure. Unless otherwise explicitly specified and limited, the terms “mounted”, “attached”, “connected” should be understood in a broad sense, e.g., it may be a fixed connection, a detachable connection or an integral connection; it may be a mechanical connection or an electrical connection; it may be a direct attachment, or an indirect attachment through an intermediate medium; and it may be a communication within two elements. For those of ordinary skill in the art, the specific meanings of the above terms in this disclosure can be understood on a case-by-case basis.

It should be noted that in this disclosure, relational terms such as “first” and “second” are used merely to distinguish one entity or operation from another entity or operation and do not necessarily require or imply the existence of any such actual relationship or sequence between these entities or operations. Moreover, the terms “include”, “comprise”, or any other variants thereof are intended to cover non-exclusive inclusion, so that a process, method, item, or device including a series of elements includes not only those elements but also other elements not explicitly listed, or further includes inherent elements of such process, method, item, or device. An element preceded by “includes a. ” does not, without more constraints, preclude the existence of additional identical elements in the process, method, article, or device that includes the element.

The foregoing descriptions are merely specific implementations of this disclosure, so that a person skilled in the art can understand or implement this disclosure. Various modifications to these embodiments will be readily apparent to those skilled in the art, and the general principles defined herein may be implemented in other embodiments without departing from the spirit or scope of this disclosure. Therefore, this disclosure will not be limited to the embodiments shown herein but is to be accorded the widest scope consistent with the principles and novel features of disclosed herein.

What is claimed is:

1. A optical cable sealing assembly, comprising a first injection-molded part (1), a gel part (2) capable of elastically deforming, and a second injection-molded part (3), wherein the first injection-molded part (1) is provided with a first profiling groove (1-1) for inserting the gel part (2), the second injection-molded part (3) is provided with a second profiling groove (3-1) for inserting the gel part (2), the first injection-molded part (1) is provided with a plurality of first optical fiber mounting holes (1-2) for mounting optical fibers and a first connecting hole (1-3) used for being fixedly connected with the second injection-molded part (3) through a threaded fastener, the gel part (2) is provided with a plurality of second optical fiber mounting holes (2-1) for mounting optical fibers and a second connecting hole (2-2) for the threaded fastener to pass through, the second injection-molded part (3) is provided with a plurality of third optical fiber mounting holes (3-2) for mounting optical fibers and a third connecting hole (3-3) used for being fixedly connected with the second injection-molded part (3) through the threaded fastener, the first optical fiber mounting holes (1-2), the second optical fiber mounting holes (2-1), and the third optical fiber mounting holes (3-2) are coaxially arranged in a one-to-one correspondence, the first connecting hole (1-3), the second connecting hole (2-2), and the third connecting hole (3-3) are coaxially arranged in a one-to-one correspondence, and a branching clamp (4) is disposed in each of the coaxially arranged first optical fiber mounting hole (1-2), second optical fiber mounting hole (2-1), and third optical fiber mounting hole (3-2).

2. The optical cable sealing assembly according to claim 1, wherein a diameter of the first optical fiber mounting hole (1-2) corresponds to a diameter of the third optical fiber mounting hole (3-2).

3. The optical cable sealing assembly according to claim 2, wherein a diameter of the second optical fiber mounting hole (2-1) is less than or equal to the diameter of the first optical fiber mounting hole (1-2).

4. The optical cable sealing assembly according to claim 3, wherein the branching clamp (4) is a flat leather fiber branching clamp (4-1) or a bundle-like fiber branching clamp (4-2).

5. The optical cable sealing assembly according to claim 4, wherein a cross-sectional shape of the flat leather fiber branching clamp (4-1) is I-shaped, and an outer diameter of the flat leather fiber branching clamp (4-1) corresponds to the diameter of the first optical fiber mounting hole (1-2).

6. The optical cable sealing assembly according to claim 5, wherein an outer peripheral surface of the flat leather fiber branching clamp (4-1) and inner peripheral surfaces of the first optical fiber mounting hole (1-2), the second optical fiber mounting hole (2-1), and the third optical fiber mounting hole (3-2) enclose two flat leather fiber optical cable mounting holes arranged in mirror symmetry, and a cross-sectional shape of the flat leather fiber optical cable mounting hole corresponds to a cross-sectional shape of a bundle-like fiber optical cable (6).

7. The optical cable sealing assembly according to claim 4, wherein the bundle-like fiber branching clamp (4-2) comprises three fan-shaped body portions arranged in rotational symmetry relative to a central axis of the first optical fiber mounting hole (1-2), the center of each fan-shaped body portion is located on the central axis of the first optical fiber mounting hole (1-2), and an outer diameter of each fan-shaped body portion corresponds to the diameter of the first optical fiber mounting hole (1-2).

8. The optical cable sealing assembly according to claim 7, wherein an outer peripheral surface of the bundle-like fiber branching clamp (4-2) and inner peripheral surfaces of the first optical fiber mounting hole (1-2), the second optical fiber mounting hole (2-1), and the third optical fiber mounting hole (3-2) enclose three bundle-like fiber optical cable mounting holes arranged in rotational symmetry, and a cross-sectional shape of the bundle-like fiber mounting hole corresponds to a cross-sectional shape of a bundle optical fiber (5).

9. The optical cable sealing assembly according to claim 1, wherein a central axis of the first injection-molded part (1) is coaxially arranged with a central axis of the first connecting hole (1-3).

10. An optical fiber connector box, comprising the optical cable sealing assembly according to claim 1.

11. An optical fiber connector box, comprising the optical cable sealing assembly according to claim 2.

12. An optical fiber connector box, comprising the optical cable sealing assembly according to claim 3.

13. An optical fiber connector box, comprising the optical cable sealing assembly according to claim 4.

14. An optical fiber connector box, comprising the optical cable sealing assembly according to claim 5.

15. An optical fiber connector box, comprising the optical cable sealing assembly according to claim 6.

16. An optical fiber connector box, comprising the optical cable sealing assembly according to claim 7.

17. An optical fiber connector box, comprising the optical cable sealing assembly according to claim 8.

18. An optical fiber connector box, comprising the optical cable sealing assembly according to claim 9.
